(19) United States
(12) Patent Application Publication
(10) Pub. No.: US 2020/0104888 A1
(43) Pub. Date: Apr. 2, 2020

(54) CONTROL OF A DISTRIBUTION NETWORK

(71) Applicant: SIEMENS AKTIENGESELLSCHAFT, MÜNCHEN (DE)

(72) Inventors: Dragan Obradovic, Ottobrunn (DE); Jorge Cuellar, Baierbrunn (DE)

(21) Appl. No.: 16/611,493

(22) PCT Filed: Apr. 26, 2018
(86) PCT No.: PCT/EP2018/060666

§ 371 Date: Nov. 7, 2019

(30) Foreign Application Priority Data
May 24, 2017 (EP) 17172779.5

(51) Int. Cl. G06Q 30/02; G06Q 50/06; G06Q 30/06; G06Q 20/38; H04L 9/06

(52) U.S. Cl. CPC G06Q 30/0283; G06Q 50/06; H04L 2209/38; G06Q 20/3827; H04L 9/0643; G06Q 30/0605

(57) ABSTRACT

Provided is a bilateral transfer comprising the provision of a performance and a counter-performance, the provision of the performance necessitating the transport of a performance object by means of a distribution network, wherein a change frame indicates the range in which the performance and/or the counter-performance can be modified. Also provided is a method for controlling the transfer which includes steps of recording the performance, the counter-performance, and the change frame; transporting the performance object by means of the distribution network in dependence on an operational state of the distribution network; and determining the counter-performance based on the performance provided within the change frame.

### CROSS-REFERENCE TO RELATED APPLICATIONS

This application claims priority to PCT Application No. PCT/EP2018/060666, having a filing date of Apr. 26, 2018, which is based on European Application No. 17172779.5, having a filing date of May 24, 2017, the entire contents both of which are hereby incorporated by reference.

### FIELD OF TECHNOLOGY

The following relates to a distribution network. In particular, the following relates to the balancing process between an in-feeding and an extracting component which are connected to the distribution network.

### BACKGROUND

A distribution network is set up for the distribution of water, gas or electrical energy, for example. The medium to be distributed is conventionally supplied to the distribution network by one or a small number of feed-in systems and can be extracted by a large number of consumers.

For example, in the case of electrical energy the transition to the use of small and minimal amounts of energy has been made by distributed energy providers themselves. For example, a private household may comprise a solar energy system and participate not only as a consumer but also as a feed-in supplier. Water or wind power plants can feed small or medium-sized quantities of energy into the distribution network, and large, in particular thermal, power plants can supply large amounts of energy to the distribution network in a centralized manner.

Essentially, in the distribution network the sum of the input media streams (supply) should always equal the sum of the extracted media streams (demand). The supply can vary, for example, because daytimes and night-times can affect a solar energy system, or local weather can affect a wind power plant. The demand can be variable because, for example due to a cold spell or at night time, more energy may be consumed for heating purposes. In order to balance the media streams against each other in an improved way, a more direct exchange between suppliers and consumers is generally aimed for. In addition, feed-in and extraction conditions, in particular the remuneration, can be controlled dynamically. If, for example, there is excess supply of energy, the remuneration for energy that is fed in can fall, sometimes even into the negative range. Conversely, the remuneration may increase when too little energy is available in the distribution network—or not at the necessary position.

One problem addressed by embodiments of the invention is to organize a plurality of supplying and extracting subscribers of a distribution network in an improved way. The embodiments solve this problem by means of the subject matter of the independent claims. Dependent claims reproduce preferred embodiments.

A bilateral transfer comprises the provision of a service and a return, wherein the provision of the service requires or comprises the transporting of a service object by means of a distribution network. A modification framework specifies the range in which the service and/or the return can be modified. A method for controlling the transfer comprises steps of recording the service, the return and the modification framework; transporting the service object by means of the distribution network as a function of an operating state of the distribution network; and determining the return on the basis of the service provided within the modification framework.

The distribution network is configured for transporting the service object, which can comprise electricity, water, gas or chemicals, for example. To determine the service the service object can be quantified; in addition, other parameters, such as a time of service, a quantity or a quality can be determined.

To perform the distribution of the service object by means of a distribution network with significant numbers of both feeding-in and extracting subscribers, a direct exchange in the manner of a peer-to-peer (P2P) network can be carried out, in order to avoid unnecessary transport operations. In this process the distribution network cannot be assumed to have a tree-like topology, in which a large supplier sits at the root and many consumers at the branches. Rather, an exchange m×n can be aimed for, in which the manner in which streams of the service object pass between m suppliers and n consumers can be determined dynamically.

### SUMMARY

The embodiments of the invention are based on the finding that an agreement between a supplier and a consumer about the exchange of the service object—taking into account a return—can be affected by technical properties of the distribution network. For example, at an agreed time of the service an excess supply of the service object may exist, so that it does not make sense, or at least may be less attractive, to perform a further introduction. Such conditions can be covered by the operating state of the distribution network, so that a prior agreement made between the initiator and the consumer about the relationship between service and return must be adjusted. It is important here that the relationship should only be modified within the agreed modification framework and only as a function of the operating state of the distribution network.

The transport operation can comprise feeding in the service object at a source location and extracting the service object at a destination location. The distribution network can have a certain self-capacity, so that it is not absolutely necessary that a fed-in item is completely transported from the source location to the destination. Instead, it may be sufficient if one amount is fed in at the source location and a different amount is extracted at the destination. The distribution network is permanently installed and typically comprises no mobile transport containers or vehicles for the service object, such as a truck or a ship. The feeding in and/or the extraction of the service object is usually possible continuously. In particular, the service object can comprise energy, especially electrical energy, a liquid or a gas. The service object can be measurable, but not countable.

The agreement on the service and return and the modification framework is usually made before the activation of the service.

An availability of the service object in one embodiment is determined at the time when the transport takes place in the distribution network, wherein the service is modified as a function of the availability. For example, a stream or volume flow of the fed-in service object can be scaled back if the availability is high, i.e. if there is a tendency for larger quantities of the service object to be available than are needed or demanded.

In a further embodiment a utilization of a component of the distribution network at the time of the transport is determined and the service is modified depending on the utilization. The component can comprise, for example, a cable or a distribution device and the component can be assigned a capacity indicating how much of the service object can be passed through it per unit time. The utilization indicates the size of the portion of the available capacity that is being used. If the utilization is high then an inbound or outbound current or volume flow can be reduced.

The modification framework can comprise an upper and/or lower limit for a service parameter in terms of the service object. The service parameter can relate, for example, to a time of the service, a quantity or a quality of the service object. The modification framework can also relate to the relationship between the service and the return. The modification framework can be used to document the circumstances under which the transfer should take place at all, and what price should ultimately be paid. The price can comprise the return. A part of the return can be remitted to another party which operates the supply network, and/or performs the implementation of the transfer.

The relationship between the service and the return can be specified within the overall modification framework by means of a function. Such a function is also called injective. The function allows the relationship to be specified without further negotiations or approvals. As a result, once the transfer has been specified it can be controlled fully automatically without interruption.

The service may be provided by a first party and the return rendered by a second party, wherein the transporting is controlled by a third party. The third party alone determines the return as a function of parameters of the service object during its transport. The third party may be given a special position of trust, since only they can comprehensively assess the operating state of the distribution network. It is therefore proposed that the third party also controls the processing of the transfer.

The service, the return and the modification framework can be specified by means of a smart contract. A smart contract typically comprises a protocol which represents a contract, and which can be implemented fully automatically. In particular, an objectively identifiable influencing factor can be taken into account, which can influence the price, in particular, as has already been commented on above. Contract clauses can be formulated algorithmically and compliance with them can be ensured automatically.

The transaction can be secured by means of a blockchain. In this process, a plurality of transactions are chained together using cryptographic values, so that the integrity of all transactions is guaranteed. A subsequent modification of a transaction parameter is thus impossible. The process uses a distributed consensus mechanism (for example, proof-of-work, proof-of-stake, proof-of-burn or proof-of-activity), in order to specify the transaction.

The return can comprise a transfer by means of a digital means of payment, for example, a crypto-currency. The means of payment may be a convertible currency or have monetary value. The transfer of the return can involve application of principles of cryptography in order to implement a distributed, trustworthy and secure digital payment system. Many well-known approaches exist for exchanging the return, which will not be examined further here. The crucial point is that the return can be influenced by a technical parameter which relates to the distribution network. The influence takes place automatically and is suitable for influencing the technical parameter. For example, if a component of the distribution network for energy is overloaded, by lowering the price for in-feed energy it is possible to ensure that less energy is fed in so that the overload can be reduced as a result.

An apparatus for controlling the above bilateral transfer comprises a first interface for accepting details of the service, the return and a modification framework, wherein the modification framework specifies the range in which the service and/or the return can be modified; a second interface for accepting an operating state of the distribution network; and a processing device. The processing device is configured to record the transport of the service object and to define the return on the basis of a service provided within the modification framework.

The transport can be defined by one or more parameters which relate to the distribution network or the service object. For example, a time of the service, a quantity, a quality, a speed of the service or a price applicable at this time can be considered.

In one embodiment the processing device is also configured to control the transport of the service object by the distribution network. The processing device can comprise a programmable microcomputer or microcontroller. The processing device is configured to execute all or part of the method described above. To do so, the method can be provided in the form of a computer program product (non-transitory computer readable storage medium having instructions, which when executed by a processor, perform actions) or stored on a computer-readable data carrier. The advantages and features of the method can be related to the apparatus and vice versa.

A system for controlling the above-described bilateral transfer comprises a distribution network which is configured to feed in a service object at a source location and to provide the service object at a destination; an apparatus for determining an operating state of the distribution network; and a processing device. The processing device is configured to record the service, the return and the modification framework; to record a transport of the service object by means of the distribution network depending on the operating state of the distribution network; and to determine the return on the basis of the service provided within the modification framework.

The processing device can be comprised by the above-described apparatus, and the apparatus can be covered by the system.

### BRIEF DESCRIPTION

Some of the embodiments will be described in detail, with references to the following Figures, wherein like designations denote like members, wherein:

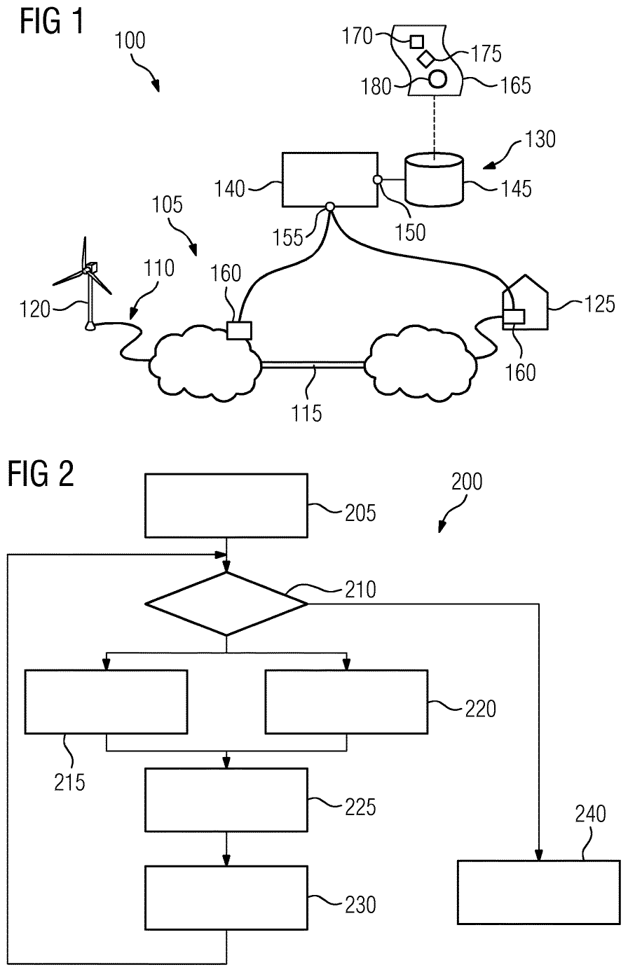

FIG. 1 shows an example system; and

FIG. 2 a flow chart of a method.

### DETAILED DESCRIPTION

FIG. 1 shows an example system 100. The system 100 comprises a distribution network 105, which is configured for transporting a service object 110 and comprises at least one component 115. The distribution network 105 is connected to one or more first parties 120, here also referred to as suppliers 120, which can feed the service object 110 into the distribution network 105, and one or more second parties 125, which can extract the service object 110 from the distribution network 105 and are also referred to here as consumers 125. The distribution network 105 can be controlled by a third party 130, which here is also called an operator 130.

In the embodiment shown the supply network 105 is configured for transporting electrical energy (electric current), in other embodiments, however, another substance, a medium, in particular a fluid, or any other form of energy can also be transported. In each case, the supply network 105 is a technical-physical facility, without which the transport cannot be performed. The component 115 can be assigned a capacity, which indicates how much of the service object 110 the component is able to transport. The capacity can determine the usability of the supply network 105.

The operator 130 comprises or controls an apparatus 135, which can comprise a processing device 140 and, optionally, a storage device 145. By means of an optional first interface 150, the apparatus 135 can accept information, in particular via a contract which will be described in more detail below, and by means of a second interface 155 it can determine an operating state of the distribution network 105. For this purpose the second interface 155 can be attached to a scanning device 160 on or in the distribution network 105, on a component 115, on the supplier 120, on the consumer 125, or between the supply network 105 and the supplier 120 or the consumer 125.

By means of the scanning device 160, the third party 130 can function as an “oracle” with respect to a contract 165. The third party 130 acts as a neutral authority that provides a parameter which affects the execution of a contract 165, as will be explained in more detail below.

The transport of the service object 110 in the distribution network 105 is based on a contract 165, which can ultimately represent a contract or an agreement which the parties 120-130 involved have agreed upon. The contract 165 comprises a service 170, a return 175 and a modification framework 180. The service 170 consists of the provision of the service object 110, wherein the service 170 can be assigned a time, a feed-in location, an extraction location, an amount, a quality, a current or volume flow or different or additional attributes. The return 175 can be defined virtually in any desired way, typically it relates in particular to the transfer of a means of payment, in particular a digital one, for example a crypto-currency, from the consumer 125 to the supplier 120. Usually a portion of the return 175 is also allocated to the operator 130.

The contract 165 also defines the relationship that should exist between the service 170 and the return 175. The relationship can be specified as a fixed value or be defined as a function of one or more of the above-mentioned parameters. This relationship can also be called a price, although the return 175 does not need to be in a monetary form.

The contract 165 is usually set at a time at which not all of the conditions under which it will be fulfilled are known. For example, a delivery time—or a delivery time frame—can be in the future, wherein the capability of the supplier 120 to provide the service object 120 is not known exactly. Also, it cannot be known exactly in which operating state the distribution network 105 is at the time the service is provided. There are often technical reasons prevailing which are inherent in the design, characteristics or utilization of the distribution network 105, and which influence the way in which the contract can be fulfilled.

Such reasons can be attributed to the operating state of the distribution network 105. The operating state can relate, in particular, to an availability of the service object 120 at the time in question or to the utilization of a component 115. For example, if there is a surplus of electricity in the distribution network 105 illustrated, then under certain circumstances the infeed of additional electricity is not feasible or not possible for technical reasons. If the capacity of a component 115 is exhausted, a transport by the component 115 can be restricted, risky or even impossible.

It is proposed to define the service 170 and the return 175 such that their conditions or their interaction can be modified by the operator 130 if there is a technical requirement to do so at the time of the provision of the service 170. In particular, the relationship between the service 170 and the return 175, which is commonly also known as the price, can be modified in order to prefer or make more attractive the infeed or the extraction of the service object 120. In this case, on conclusion of the contract 165 the conditions can be specified under which all parties 120, 125, 130 are still prepared to fulfill the contract 165. For example, if the price drops below a predetermined threshold, the supplier 120 may have no further interest in the performance of the contract 165. If the price rises above a different threshold, then the consumer 125 may lose interest in the contract 165. If a problem arises in the area of the energy distribution network 105, then the operator 130 can no longer fulfill the contract 165.

The price can be specified as a function of a parameter of the energy distribution network 105. The function can have a linear, polynomial or other form and is defined at least in the range of the conditions under which the contract 165 is to be fulfilled.

The contract 165 can be secured by means of a blockchain procedure, so that it cannot be changed unnoticed after its conclusion. The parties 120-130 can thereby be bound to the contract 165 in an improved way. The execution of the contract 165 can be fully automatic. In this context, the return 175 can be implemented, enabled or at least defined. The return 175 may require a money transfer or a credit note. This may require a further authority which acts as a trustee and manages an account, for example, or a similar entity. This authority may coincide with the operator 130.

The administration of the smart contract 165 can comprise negotiating conditions, the storage of an approval by the parties and the validation of the contract 165 by another trusted party. This other party may be formed, in particular, by the third party 130.

For the administration of contracts 165 a separate infrastructure may be necessary in order to ensure a sufficient degree of security, availability and trustworthiness. This may involve, in particular, maintaining an asset register, in other words, a list of the component parts of a contract 165 or a plurality of contracts 165. The asset register can be mirrored, in other words its content is updated synchronously on a periodic or event-controlled basis at different facilities. The mirroring is carried out in a fault-tolerant manner. The execution of a contract 165 can be secured using hash chains, in particular by means of a blockchain procedure in which all transactions are chained together using cryptographic methods.

FIG. 2 shows a flow diagram of a method 200 for controlling a bilateral transfer.

The method 200 is configured to control the system 100 of FIG. 1 or one or more of its parts.

In a step 205, the service 170, the return 175 and the modification framework 180, which are usually included in a contract 165, are recorded. Further conditions may be specified which comprise, for example, a variable price, i.e. a parameter-dependent relationship between the service 170 and the return 175. The parameter in this case refers primarily to the distribution network 105, one of its components 115 or properties, or the transport process with which the service object 120 is transported by the distribution network 105. One or more conditions can also be specified under which the contract 165 is to be executed in general. These conditions can comprise, for example, a time, a time interval or a price. Usually, all specified conditions must be met for the contract 165 to be executed.

In a step 210, a check is made to determine whether the one or more conditions are met. If this is the case, in a step 215 the transporting of the service object 110 can be recorded. To achieve this, for example, one of the scanning devices 160 can be queried, which record the flow of the service object 110 into, through or out of the distribution network 105.

An operating state of the distribution network 105, which can affect the transport process, is determined in parallel with the transport process in a step 220.

The operating state can determine whether and in what way and/or to what extent the contract 165 is modified from its original parameters. To this end, in a step 225 on the basis of the determined operating state and the observed transport it can be determined which service 170 has been provided, and how the service 165 provided is to be valued.

Accordingly, in a step 230, on the basis of the contract 165 and the applicable parameters it can be determined which return 175 should be assigned to the service 170. In so doing, the originally concluded contract 165 can be modified within the modification framework 180. In one embodiment, for example, the operating state of the distribution network 105 affects the price, which describes the relationship between service 170 and return 175. In one embodiment, the amount of the service object accepted or provided by the distribution network 105 (possibly, per unit time) is based on the operating state.

The return 175 usually flows from the consumer 125 to the supplier 120, wherein a portion of the return 175 can flow to the operator 130. Variations of this are also possible, for example, the operator 130 can also owe a return to the supplier 120 if the in-feed had to be reduced or denied on the basis of the operating state of the distribution network 105.

The method 200 can return to step 210 and be executed again. If in step 210 it was determined that the conditions of the contract 165 are not fulfilled, the transport can be aborted in a step 240. The currently applicable conditions can continue to be monitored in order to restart the transport at a later time if necessary, as described above.

### SUMMARY

In the following explanation, the contract 175 is also referred to as a contract or smart contract. The supplier 120 is called A and the consumer 125 is called B. The operator 130 can coincide with a party TP. The service object 110 is called G.

A smart contract usually comprises a protocol that can be implemented by one or more computers or other devices and represents a contract. A standard smart ontract usually has the abstract form

### C(A,B,$)

which can be expressed as: “Entity A pays entity B the amount $ in an electronic currency”. The currency may comprise, in particular, a crypto-currency such as Bitcoin.

In one variant the smart contract exists in the form

### C(A,B,G)

which can be expressed as “Entity A transfers the ownership over the service object G to entity B”.

There are also other types of smart contracts, in which a deposit is paid (which can be paid back if a predefined event occurs) or a multiple payment of a plurality of instances is effected (and the smart ontract can be withdrawn or confirmed depending on decisions of the entities, and possibly on external conditions).

It is not of concern here how a smart contract is enforced, only what the smart contract can express and how it can be automatically modified after its conclusion on the basis of a condition.

The preferred method for a smart contract is termed an “oracle”, where the oracle represents an online service that provides certain data, such as the football results, the value of a share, etc. An oracle is usually replicated by multiple providers, to increase its reliability and security. Here, the smart contract can be specified as an expression of the form

C (A, B, $ [location G], c),
which can be expressed as “Entity A gives the amount $ [or the ownership of the service object G] to entity B, if the condition c is true (within a predefined time window) and if the transaction is not then invalid.” Other types of smart contracts support auctions, finding the highest bidder and revoking the transactions of all other bidders.

It is proposed to set up a smart contract between at least two entities A and B in such a way that the smart contract can be modified in a specified manner by a trusted third party TP (“trusted party”) before the transaction is accepted as valid. In the case of a Smart Grid 105 for the distribution of energy a user A (supplier 120) can decide to sell a certain quantity # of electrical energy (the service object 110, expressed in kWh, for example) at a specific price $ to another entity B at a specific time or within a specific time window T. The smart contract would then appear as follows:

### C(A,B, #, $, T)

This does not describe how the contract between A and B has come into being, for example, by means of an auction or another method. A method is now proposed to conclude the contract with two extensions:

1.) A “meta-contract” sets out the conditions under which a smart contract C is valid and how its conditions can be changed in an approval phase. The meta-contract specifies the modification framework for the actual contract.

2.) A “modified contract” specifies how the confirmed and modified contract was concluded. Expressed another way, the modified contract defines which specific contract, which originated from a meta-contract on the basis of a predefined condition, actually applies. In the following, variables with an apostrophe designate the modified variable in each case; for example, V is modified to V′.

A valid contract C can be created as follows:

1.) An entity T creates a meta-contract M, which can be used by the other entities later as a framework contract or master agreement. The entity T can be a trusted authority, which can be formed or operated, in particular, by the operator 130. The meta-contract M has the form:

M=C(T3P, c, R(#, $, T, #′, $′, T′, c, c′)),
where T3P is the trusted authority or a member of a group of trusted authorities, which is allowed to modify and confirm a proposed contract, c is a fixed (static) condition, R is a program (executable program code) which outputs TRUE or FALSE (or 0 or 1), depending on whether a pre-defined condition Rcond on (#, $, T, #′, $′, T′, c, c′) is TRUE.

R thus ensures that the old values #, $, T, the modified values #′, $′, T′, the statically expressed condition c and the additional condition c′ satisfy the pre-defined relation Rcond. In the case of a Smart Grid, R can be as simple as #′<=#, which means that the modified value of the transported electrical energy is less than or equal to the contractually accepted value. This kind of clause can be useful in preventing an overloading of the exchange network 105.

2.) The entities A and B agree on the conditions of a proposed contract M: C=C (A, B, M, #, $, T), which can be expressed as “A commits to sell a certain amount # of electrical energy (e.g. in kWh) to another entity B at a certain time or in a certain time interval T for a particular value $, wherein the contract is dependent on the additional conditions of the meta-contract M”. The meta-contract M therefore defines the modification framework in which the concluded contract C can be modified.

In one implementation, M need not be a copy of a meta-contract but may simply be a kind of pointer or reference to the meta-contract, in particular a hash pointer to M.

3.) In order for this contract to be valid, a trusted third party (for example, the third party 130), which is authorized by the meta-contract M to perform this role, can amend the contract C before validating it. This is achieved by a new amended contract:

RC(C(A, B, M, #, $, T), T3P, #′, T′, c′)=RC (C, T3P, #′, $′, T′, c′), which can be expressed as: “TP validates and accepts the contract C (A, B, M, #, T) which was proposed by A and B, but modifies the values of # to #′, $ to $′ and T to T′. In the case of the Smart Grid it appears useful to have the operator 130 modify the amount # of electrical energy or to add an additional condition c′ in order to ensure the stability of the electrical exchange network 105.

The manner in which the values of #, $ and T are modified by T3P and the additional condition c′ is added must be in accordance with the meta-contract C, which is referred to in the contract. That this is indeed the case, i.e. that an authorized party has amended and approved the contract in an authorized manner, should be reviewed by the entities participating in the system as part of their verification task in the context of smart contracts. In one implementation C does not need to be a copy of the proposed contract, but can be simply a kind of pointer or reference to the contract C.

Although the present invention has been disclosed in the form of preferred embodiments and variations thereon, it will be understood that numerous additional modifications and variations could be made thereto without departing from the scope of the intention.

For the sake of clarity, it is to be understood that the use of “a” or “an” throughout this application does not exclude a plurality, and “comprising” does not exclude other steps or elements. The mention of a “unit” or a “module” does not preclude the use of more than one unit or module.

1. A method for controlling a bilateral transfer, which comprises a provision of a service and a return, wherein the provision of the service requires a transport of a service object by means of a distribution network, the method comprising:
recording the service and the return;
recording a modification framework, which specifies a range in which the service and/or the return can be modified;
transporting the service object by means of the distribution network as a function of an operating state of the distribution network; and
determining the return on a basis of the service provided within the modification framework.

2. The method as claimed in claim 1, wherein the transporting comprises feeding in the service object at a source location and extracting the service object at a destination location.

3. The method as claimed in claim 1, wherein an availability of the service object in the distribution network at a time of the transport is determined and the service is modified according to the availability.

4. The method as claimed in claim 2, wherein a utilization of a component of the distribution network at a time of the transport is determined and the service is modified according to the utilization.

5. The method as claimed in claim 1, wherein the modification framework comprises an upper limit and/or a lower limit for a service parameter in terms of the service object.

6. The method as claimed in claim 1, wherein a relationship between the service and the return is defined within an overall modification framework by means of a function.

7. The method as claimed in claim 1, wherein the service is provided by a first party and the return is provided by a second party, wherein the transportation is controlled by a third party and only the third party determines the return as a function of parameters of the service object during the transport thereof.

8. The method as claimed in claim 1, wherein the service, the return and the modification framework are defined by means of a smart contract.

9. The method as claimed in claim 1, wherein the transaction is secured by means of a blockchain.

10. The method as claimed in claim 1, wherein the return comprises a transfer of a digital means of payment.

11. An apparatus for controlling a bilateral transfer, which comprises a provision of a service and a return, wherein the provision of the service requires the transporting of a service object by means of a distribution network, the apparatus comprising:
a first interface for accepting details of the service, the return and a modification framework, wherein the modification framework specifies a range in which the service and/or the return can be modified;
a second interface for accepting an operating state of the distribution network; and
a processing device, which is configured:
to record the transport of the service object, and
to determine the return on a basis of a service delivered within the modification framework.

12. A system for controlling a bilateral transfer, which comprises a provision of a service and a return, wherein the provision of the service requires the transporting of a service object by means of a distribution network, the system comprising:
a distribution network, which is configured to feed in a service object at a source location and to provide the service object at a destination location;
an apparatus for determining an operating state of the distribution network; and
a processing device, which is configured:
to record the service, the return, and a modification framework, wherein the modification framework specifies a range in which the service and/or the return can be modified;
to record a transporting of the service object by means of the distribution network as a function of an operating state of the distribution network; and
to determine the return on the basis of the service provided within the modification framework.
